(19) United States
(12) Patent Application Publication
(10) Pub. No.: US 2002/0013732 A1
(43) Pub. Date: Jan. 31, 2002

(54) Joint purchase counter auction using internet

(75) Inventor: Katsutoshi Takata, Tokyo (JP)

Correspondence Address: ARMSTRONG,WESTERMAN, HATTORI,, MCLELAND & NAUGHTON, LLP, 1725 K STREET, NW, SUITE 1000, WASHINGTON, DC, 20006, US

(73) Assignee: Yugen Kaisha Adnet, Tokyo (JP)

(21) Appl. No.: 09/739,793

(22) Filed: Dec. 20, 2000

(30) Foreign Application Priority Data
May 10, 2000 (JP) 2000-137121

(51) Int. Cl. G06F 17/60

(52) U.S. Cl. 705/26

(57) ABSTRACT

A system for implementing over the Internet a counter auction system which invites a large number of goods selling companies to compete for better goods prices on an online shopping forum. The joint purchase/sale information analysis unit on the Web server compares the conditions on the joint purchase program offered by the sellers based on the number of purchase reservations made by the Internet users who accessed the Web site and then puts the sellers under competition for a better condition on the joint purchase program of the commodities. The seller who offers the best selling condition is immediately given the right to sell its commodity. With this system, the purchasers can do the online shopping over the Internet in a short period of time and under good conditions.

### BACKGROUND THE OF THE INVENTION

The present invention relates to a counter auction system for a group of users of the Internet to jointly purchase a commodity online, and more particularly to a counter auction system using the Internet whereby a group of users wishing to jointly purchase a commodity can automatically have selling companies compete against one another.

In recent years online shopping has become popular as the Internet has come into wide use. The online shopping is normally done as follows. At each shopping site, the user checks the specifications and prices of commodities, determines which commodity to buy, enters necessary information in a purchase application form and makes payment. The user decides what he or she likes to buy by simply visiting the related sites and checking the goods. To make comparison with cheaper goods, however, the user must take trouble to surf the Internet and repeat window shopping.

There have been commodity selling companies which at particular sites offer commodities at low prices to a large number of users. In this case, because the prices presented at one site are limited to the commodities from a particular company, it is not clear at what prices the similar commodities can be purchased from other companies.

### SUMMARY OF THE INVENTION

Under these circumstances, there has been a demand for the development of a system that implements a counter auction method over the Internet for having a number of commodity sellers bid their best prices against each other in an online shopping forum. The present invention has been accomplished to meet this demand.

According to one aspect of the present invention, there is provided a counter auction system which comprises: a server on an Internet site; a plurality of computers of registered merchandise sellers connected to the server over the Internet; and a plurality of computers of purchasers connected to the Internet; wherein the server includes: a home page generation means for generating a home page on the server and for displaying a sales condition on a joint purchase program offered by an arbitrary registered seller, including a minimum number of purchase reservations and a selling price of specified merchandise, and a term of the offer; counter means for counting up each application for purchase and displaying the number of purchase reservations at the home page; automatic e-mail sending means for disclosing the number of purchase reservations and the selling price offered by the arbitrary registered seller to other registered sellers on a predetermined date before the end of the term and for inviting them to offer new sales conditions on the joint purchase program; and comparison means for comparing new sales conditions on the joint purchase program offered in response to the invitation with the sales conditions on the joint purchase program offered by the arbitrary registered seller; wherein the home page generation means sets as a content of the home page the sales conditions on the joint purchase program judged by the comparison means to be a better sales condition; wherein the automatic e-mail sending means informs the purchase applicants of a conclusion of the joint purchase contract on the date when the term expires.

Further, it is desired that the automatic e-mail sending means informs the arbitrary registered seller that a joint purchase program dealership has been intercepted by another registered seller who has offered a better sales condition on the joint purchase program in response to the invitation.

Further, it is desired that if there is any registered seller who has voluntarily responded to the invitation before the predetermined date, the comparison means compare a sales condition on the joint purchase program offered by the voluntary seller with that of the arbitrary seller to determine whether the offer is better or not before the automatic e-mail sending means invites by e-mail on the predetermined date other sellers to offer their own conditions on the joint purchase program and that if it is found to be a better sales condition, the home page generation means rewrites the content of the home page.

### BRIEF DESCRIPTION OF THE DRAWINGS

FIG. 1 is an explanatory diagram showing a system configuration for implementing a joint purchase counter auction using the Internet according to the present invention;

FIG. 2 is a first part of a flow chart of the joint purchase counter auction using the Internet according to the invention; and

FIG. 3 is a second part of the flow chart of the joint purchase counter auction using the Internet according to the invention.

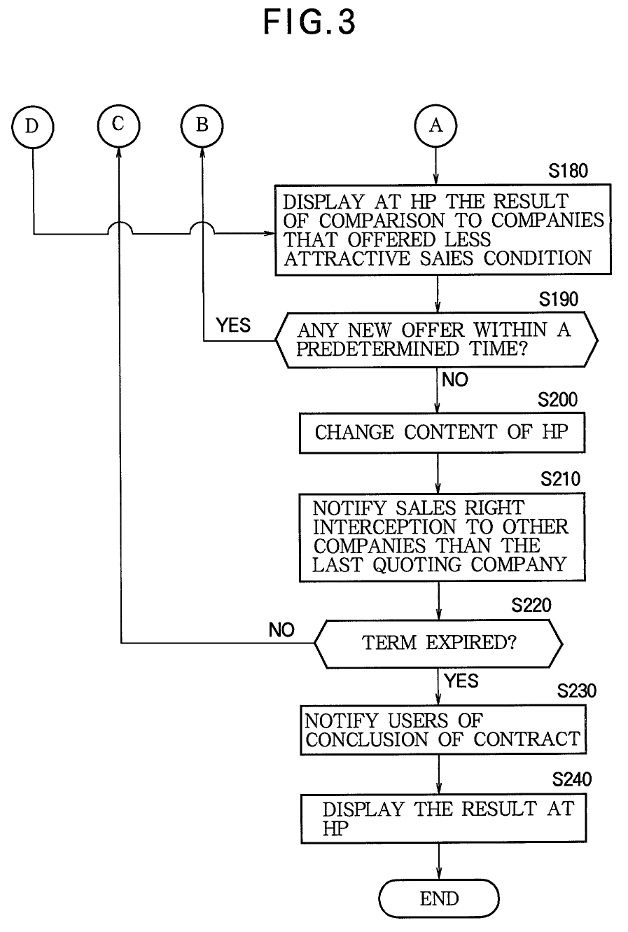

### DETAILED DESCRIPTION OF THE EMBODIMENTS

Now, as one embodiment of the invention, a counter auction system using the Internet that enables a joint purchase program by a group of users will be described by referring to the accompanying drawings.

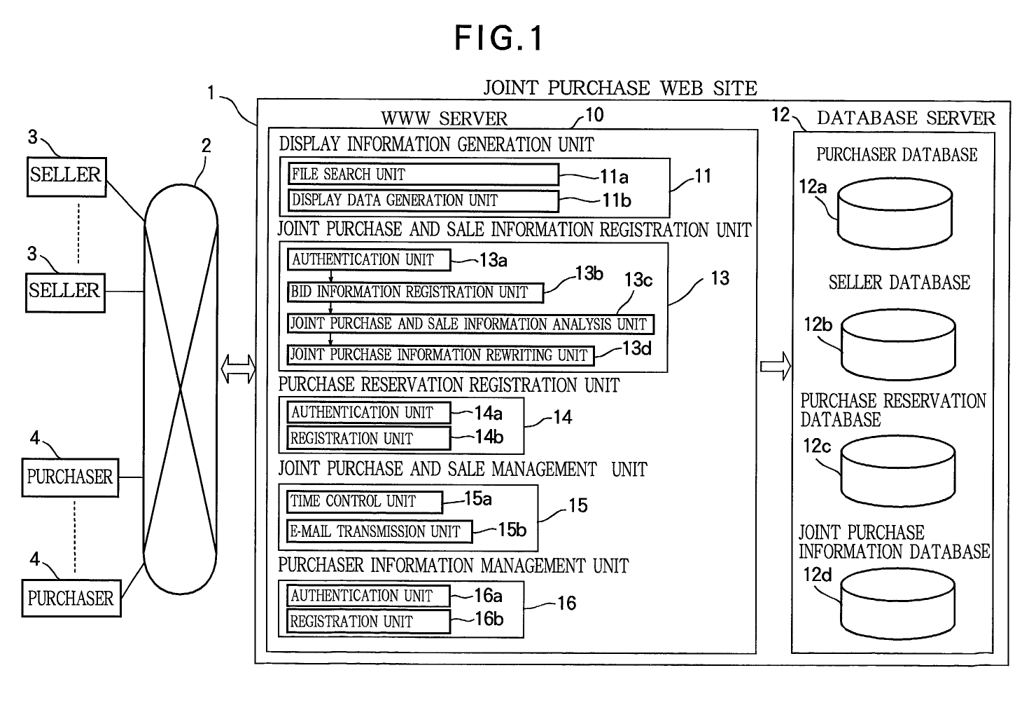

FIG. 1 shows an overall configuration of the counter auction system, in which reference numeral 1 represents a joint purchase Web site (hereinafter simply referred to as a site) as a center where the counter auction is performed.

The joint purchase site 1 is connected via the Internet 2 to personal computers, not shown, of a plurality of commodity selling companies or sellers 3 that specialize in the sale of jointly purchased commodities (hereinafter referred to as sellers'PCs). In the same manner, the site 1 is also connected over the Internet to personal computers, not shown, of an unspecified number of users or purchasers 4 wishing to jointly purchase commodities (referred to as purchasers'PCs).

At the site 1 are provided a WWW server 10 connected to the Internet 2 and a database server 12 connected to the WWW server 10, both of which are used for authentication when information is exchanged between the PCs of the purchasers 4 and the PCs of the sellers 3, both constitutional members of the joint purchase and sale.

The WWW server 10 includes a display information generation unit 11 incorporating CGI (Common Gateway Interface) to generate a home page using information exchanged between the sellers'PCs and purchasers'PCs and already registered data; a joint purchase/sale information registration unit 13 which authenticates the sellers wishing to sell commodities in bulk and registers sales information provided by the sellers; a purchase reservation registration unit 14 that authenticates the purchasers 4 who make a purchase reservation and registers their purchase reservations; and a joint purchase/sale management unit 15 that controls the time of joint purchase and sale and notification thereof through e-mail.

The database server 12 has a purchaser database 12a, a seller database 12b, a purchase reservation database 12c, and a joint purchase information database 12d, all interconnected with one another. The information stored in the joint purchase information database is classified according to items. The display information generation unit 11 in the WWW server 10 exchanges information over the internet 2 with the outside world, i.e., the sellers' PC input thereinto and and the purchasers' PC output therefrom.

To describe in more detail, the display information generation unit 11 includes a file search unit 11a and a display data generation unit 11b. The joint purchase/sale information registration unit 13 includes an authentication unit 13a, a bid information registration unit 13b, a joint purchase/sale information analysis unit 13c, and a joint purchase information rewriting unit 13d. The purchase reservation registration unit 14 includes an authentication unit 14a and a registration unit 14b. The joint purchase/sale management unit 15 includes a time control unit 15a and an e-mail sending unit 15b.

In implementing the present invention it is assumed that there are sites on the Internet where goods are evaluated. The server 10 on the site 1 invites companies, which sell goods that are popular at these goods evaluation sites, to quote the prices of their merchandise. The selling companies that have responded to the invitation over the Internet or off-line are registered in the seller database 12b of the database server 12 as the sellers participating the joint purchase and sale system by the site administrator, who issues IDs and passwords to the selling companies. When a company withdraws from the system or when changes occur with the sellers' information, the selling company in question makes an online access to the authentication unit 13a using its ID and password, makes necessary changes and writes the changed information over the seller database 12b.

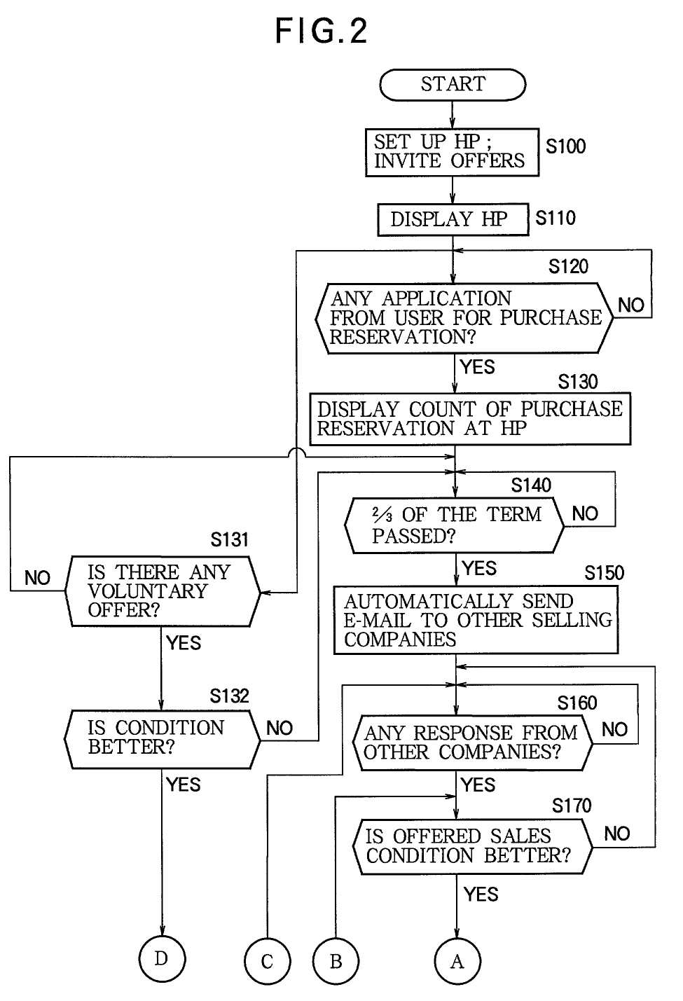

With the above procedure having been taken, the WWW server 10 sets up a home page by the display information generation unit 11 as shown in FIG. 2 (S100). The home page includes columns in which the selling companies are to write their company names, commodity names, minimum numbers of purchase lots, prices and terms. After looking at this home page, some registered selling company interested in the joint purchase program, for example A company, uploads its sales conditions in a predetermined format of the home page (S110) and at the same time stores information, such as the company name, commodity name, the minimum number of purchase lots, the price and term, in the joint purchase information database 12d.

For example, this company presents its company name and sales condition specifying that they will sell a commodity A at a price of ¥100,000 if they receive an order for 100 sets of said commodity and that this offer is valid for 30 days.

An Internet user who has accessed this site checks the content of the home page and, if interested in the joint purchase counter auction of this invention, registers with the system as a purchasing member by entering his or her address, name, telephone number and e-mail address. The user has his ID and password issued by a registration unit 16b of a purchaser information management unit 16. The server stores information associated with the member registration in the purchaser database 12a. When a registered purchaser withdraws from the system or when changes occur with registered member information, the member in question makes access through the authentication unit 16a to the registration unit 16bwhere he or she makes necessary changes to the information stored in the purchaser database 12a. If the seller's sales condition presented at the home page is acceptable, the user as a purchaser applies for purchase reservation. That is, the user first clears the authentication procedure in the authentication unit 14a of the purchase reservation registration unit 14 and then applies for the purchase reservation in the registration unit 14b. At the same time, the information on the purchase reservation made is stored in the joint purchase information database 12d. In the meantime, the site continuously monitors new applications for purchase reservation (S120). Whenever an application for purchase reservation is made, the total number of applicants counted by the site of the home page, i.e., by the application acceptance counter (not shown), is displayed in the purchaser number column (S130). If no applications are made, this monitoring is continued.

A date at two thirds of the 30-day application acceptance term, i.e. 20th day, is set. A day counter (not shown) of the time control unit 15a of the joint purchase/sale management unit 15 checks whether or not the 20th day is reached (S140). If the 20th day has been reached, the e-mail sending unit 15b of the joint purchase/sale management unit 15 automatically transmits e-mails to all registered selling companies except for the company A, urging them to participate in the joint purchase and sale and to present their sales conditions at the home page (S150). If the 20th day is not reached, this checks is repeated.

In the joint purchase/sale information registration unit 13, there is provided an application acceptance counter (not shown) which checks whether or not there is any offer from the other selling companies (S160). When, for example, a company B applies as a seller on the joint purchase program, the company clears the authentication procedure in the authentication unit 13a of the joint purchase/sale information registration unit 13 and then registers itself with the bid information registration unit 13b. The joint purchase/sale information analysis unit 13c compares the sales condition of the company B with that of the company A (S170). If there is no application from other selling companies, this monitoring is repeated.

If the sales condition of the company B is more attractive to the purchasers, the result of comparison is displayed at the home page (S180) for a predetermined time, for example 48 hours, set by the time control unit 15a of the joint purchase/sale management unit 15 in order to notify the result of comparison to the company A, whose sales condition has become less attractive. Further, it is preferred that the e-mail sending unit 15b automatically transmit an e-mail to the company A, informing that there is an offer from another company more attractive than that of the company A and urging the company A to reconsider its sales condition and make another offer of a more desirable sales condition.

Next, the application acceptance counter of the joint purchase/sale information registration unit 13 checks whether or not there is a response within the predetermined time, i.e., 48 hours (S190). If no response is received, the joint purchase information rewriting unit 13d rewrites the content of the home page with the sales condition of the company B. If a further offer is received from, for example, a company C, the joint purchase/sale information analysis unit 13c compares the sales condition of the company C with that of the company B (S170). If the sales condition of the company B is more preferable, the joint purchase information rewriting unit 13d causes the display data generation unit 11b to rewrite the content of the home page with the sales condition of the company B (S200).

If the sales condition of the company C is more attractive, the joint purchase information rewriting unit 13d causes the display data generation unit 11b to rewrite the content of the home page with the sales condition of the company C (S200). Then, the e-mail sending unit 15b of the joint purchase/sale management unit 15 informs all the selling companies except for a successful bidder, i.e., company B or C, that the joint purchase and sales right has been intercepted (S210).

Then, the day counter (not shown) in the time control unit 15a of the joint purchase/sale management unit 15 checks whether or not the 30th day has passed. If passed, the e-mail sending unit 15b informs the users who made purchase reservations and the successful bidder, the company B or C, by e-mail or written mail that a joint purchase/sales contract is concluded (S230). At the same time, the contract entered into is displayed at the home page (S240). The procedure is now ended. If the 30th day is not reached, the procedure returns to the step (S160) that checks for applications.

In the joint purchase counter auction system of this invention, the following step may be added. That is, before checking whether two thirds of the term has been reached or not (S140), the application acceptance counter in the joint purchase/sale information registration unit 13 checks for applications from other sellers who have looked at the home page and voluntarily applied for the joint purchase and sale (S131).

If a voluntary application is made from, for example, a company D, the joint purchase/sale information analysis unit 13c compares the sales condition of the company D with that of the company A and, if the sales condition of the company D is more attractive, writes this condition in the predetermined format of the home page (S112). The joint purchase information rewriting unit 13d requests the display data generation unit 11b to overwrite the content of the home page with this sales condition. If there is no voluntary application, the day counter in the time control unit 15aproceeds to a step where it checks whether the two thirds of the term has passed (S140). This step is repeated until the two thirds of the term is reached.

As described above, the joint purchase counter auction system using the Internet according to the present invention compares the joint purchase/sales conditions offered by different selling companies on the basis of the number of purchase reservations made by purchasers at the Web site and then puts the best offered selling price of goods on a counter auction so that a seller who offers the most attractive sales condition obtains the selling right. This ensures that the competition to offer more attractive selling condition takes place continuously and acceleratedly, obviating the need for the purchasers to search through the vast Internet for desired purchase condition and making the preferable shopping condition automatically available to the purchasers. For the sellers, taking part in this system by registering with it provides them with an opportunity to immediately secure a right to sell their commodity, leading to an increased sale.

When a new registered seller emerges who offers a better selling condition than the first arbitrary registered seller, the first registered seller is given an opportunity to present an even better condition than the new seller. This makes it possible for a better selling condition to be offered, producing the counter auction effect in the early stage of the competition.

Further, because this system can deal with a situation where a voluntary seller appears before the Web site automatically transmits the e-mail, the effect of the counter auction can be produced at an even earlier stage.

What is claimed is:

1. A joint purchase counter auction system comprising:
a server on an Internet site;
a plurality of computers of registered merchandise sellers connected to the server over the Internet; and
a plurality of computers of purchasers connected to the Internet;
wherein the server includes:
home page generation means for generating a home page on the server and for displaying a joint purchase/sales condition offered by an arbitrary registered seller, including a minimum number of purchase reservations and a selling price of specified merchandise, and a term of the offer;
counter means for counting up each application for purchase and displaying the number of purchase reservations at the home page;
automatic e-mail sending means for disclosing the number of purchase reservations and the selling price offered by the arbitrary registered seller to other registered sellers on a predetermined date before the end of the term and for inviting them to offer new joint purchase/sales conditions; and
comparison means for comparing new joint purchase/sales conditions offered in response to the invitation with the joint purchase/sales condition offered by the arbitrary registered seller;
wherein the home page generation means sets as a content of the home page the joint purchase/sales condition judged by the comparison means to be a better condition;
wherein the automatic e-mail sending means informs the purchase applicants of a conclusion of the joint purchase contract on the date when the term expires.

2. A joint purchase counter auction system according to claim 1, wherein the automatic e-mail sending means informs the arbitrary registered seller that a joint purchase/sales right has been intercepted by another registered seller who has offered a better joint purchase/sales condition in response to the invitation.

3. A joint purchase counter auction system according to claim 2, wherein if there is any registered seller who has voluntarily responded to the invitation before the predetermined date, the comparison means compares the joint purchase/sales condition offered by the voluntary seller with that of the arbitrary seller to determine whether the offer is better or not before the automatic e-mail sending means invites by e-mail on the predetermined date other sellers to offer their joint purchase/sales conditions and, if it is found to be a better condition, the home page generation means rewrites the content of the home page.
